(19) United States
(12) Patent Application Publication
(10) Pub. No.: US 2019/0227661 A1
(43) Pub. Date: Jul. 25, 2019

(54) TOUCH INPUT DEVICE

(71) Applicant: HiDeep Inc., Seongnam-si, Gyeonggi-do (KR)

(72) Inventors: Se Yeob KIM, Seongnam-si, Gyeonggi-do (KR); Bon Kee KIM, Seongnam-si, Gyeonggi-do (KR); Young Ho CHo, Seongnam-si, Gyeonggi-do (KR); Yun Joung Kim, Seongnam-si, Gyeonggi-do (KR)

(73) Assignee: HiDeep, Inc., Seongnam-si, Gyeonggi-do (KR)

(21) Appl. No.: 16/328,261

(22) PCT Filed: Jun. 15, 2017
(86) PCT No.: PCT/KR2017/006230

§ 371 Date: Feb. 25, 2019

(30) Foreign Application Priority Data
Aug. 25, 2016 (KR) 10-2016-0108575

(51) Int. Cl. G06F 3/041; G06F 3/044

(52) U.S. Cl. CPC G06F 3/0414; G06F 3/044

(57) ABSTRACT

A touch input device may be provided that includes: a cover; a display module disposed below the cover; a substrate which is disposed below the display module and is nonconductive or includes an electrically floating conductor; and a pressure electrode formed on the substrate.

### TECHNICAL FIELD

The present disclosure relates to a touch input device for pressure detection and more particularly to a touch input device which has improved sensitivity of touch pressure and has its reduced thickness.

### BACKGROUND ART

Various kinds of input devices are being used to operate a computing system. For example, the input device includes a button, key, joystick and touch screen. Since the touch screen is easy and simple to operate, the touch screen is increasingly being used to operate the computing system.

The touch screen may constitute a touch surface of a touch input device including a touch sensor which may be a transparent panel including a touch-sensitive surface. The touch sensor is attached to the front side of a display screen, and then the touch-sensitive surface may cover the visible side of the display screen. The touch screen allows a user to operate the computing system by simply touching the touch screen by a finger, etc. Generally, the computing system recognizes the touch and a position of the touch on the touch screen and analyzes the touch, and thus, performs operations in accordance with the analysis.

Here, there is a demand for a touch input device capable of detecting not only the touch position according to the touch on the touch screen but the pressure magnitude of the touch.

### DISCLOSURE

### Technical Problem

An object of the present invention is to provide a touch input device which has improved sensitivity of touch pressure by reducing a parasitic capacitance included a sensing signal output from a pressure electrode.

Also, another object of the present invention is to provide the touch input device which has its reduced thickness.

### Technical Solution

One embodiment of the present invention is a touch input device including: a cover; a display module disposed below the cover; a substrate which is disposed below the display module and is nonconductive or includes an electrically floating conductor; and a pressure electrode formed on the substrate.

One or more of components constituting the display module may have a reference potential for the pressure electrode.

The touch input device may further include a reference electrode formed directly on a bottom surface of the display module. The reference electrode may have a reference potential for the pressure electrode.

The touch input device may further include a reference electrode disposed within the display module. The reference electrode may have a reference potential for the pressure electrode.

The touch input device may further include a mid-frame disposed below the substrate. The mid-frame may have a reference potential for the pressure electrode.

The pressure electrode may be directly formed on the substrate.

When the substrate is nonconductive, an edge portion of the substrate may be connected to the bottom surface of the display module.

When the substrate is an electrically floating conductor, the substrate may include a conductive portion on which the pressure electrode is formed and an insulating member which connects an edge portion of the conductive portion with the bottom surface of the display module. The insulating member may be nonconductive.

Another embodiment is a touch input device including: a cover; a display module disposed below the cover; a substrate which is disposed below the display module and is nonconductive or includes an electrically floating conductive material; a first pressure electrode which is formed on the display module; and a second pressure electrode which is formed on the substrate and is disposed below and spaced apart from the first pressure electrode at a predetermined distance.

The first pressure electrode may be at least any one of components constituting the display module.

The first pressure electrode may be directly formed on a bottom surface of the display module.

The first pressure electrode may be disposed within the display module.

The touch input device may further include a mid-frame disposed below the substrate.

The mid-frame may have a reference potential for at least any one of the first pressure electrode and the second pressure electrode.

The second pressure electrode may be directly formed on the substrate.

When the substrate is nonconductive, an edge portion of the substrate may be connected to the bottom surface of the display module.

When the substrate is an electrically floating conductor, the substrate may include a conductive portion on which the pressure electrode is formed and an insulating member which connects an edge portion of the conductive portion with the bottom surface of the display module. The insulating member may be nonconductive.

### Advantageous Effects

Through use of the touch input device according to the embodiment of the present invention, it is possible to improve the sensitivity of the touch pressure by reducing a parasitic capacitance included a sensing signal output through a pressure electrode.

Also, it is possible to reduce the thickness of the touch input device.

### DESCRIPTION OF DRAWINGS

FIGS. 1a and 1b are schematic views of a capacitance type touch sensor and a configuration for the operation of the touch sensor;

FIGS. 2a and 2b are views showing a detailed configuration of a display module in a touch input device according to an embodiment of the present invention;

FIG. 3a is a schematic cross sectional view of the touch input device according to the embodiment of the present invention;

FIG. 3a is a schematic cross sectional view of the touch input device according to another embodiment of the present invention;

FIG. 3c is a schematic cross sectional view of the touch input device according to further another embodiment of the present invention;

FIG. 4a is a schematic cross sectional view of the touch input device according to yet another embodiment of the present invention;

FIG. 4b is a schematic cross sectional view of the touch input device according to still another embodiment of the present invention;

FIG. 5a shows a display module 200A including an LCD panel and FIG. 5b shows a display module 200B including an OLED panel;

FIGS. 6a to 6b are views for describing the coupling relationship between a display module 200 and a substrate 500 which are shown in FIGS. 3a to 4b;

FIG. 7 is an entire cross sectional view of the touch input device including the display module 200 and a substrate 500a which are shown in FIG. 6a; and

FIG. 8 is a cross sectional view of a modified example of the touch input device shown in FIG. 7.

### MODE FOR INVENTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. It should be understood that various embodiments of the present invention are different from each other and need not be mutually exclusive. Similar reference numerals in the drawings designate the same or similar functions in many aspects.

Hereinafter, a touch input device which enables pressure detection in accordance with an embodiment of the present invention will be described with reference to the accompanying drawings. In the below description, while a capacitance type touch sensor 10 is exemplified, a touch sensor 10 capable of detecting a touch position in any manner can be applied.

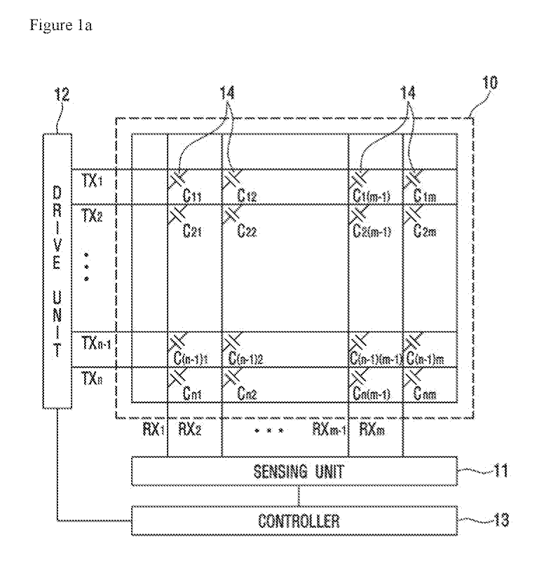

FIG. 1a is schematic views of a configuration of the capacitance type touch sensor 10 included in the touch input device according to the embodiment of the present invention and the operation of the capacitance type touch sensor.

Referring to FIG. 1a, the touch sensor 10 may include a plurality of drive electrodes TX1 to TXn and a plurality of receiving electrodes RX1 to RXm, and may include a drive unit 12 which applies a drive signal to the plurality of the drive electrodes TX1 to TXn for the purpose of the operation of the touch sensor 10, and a sensing unit 11 which detects the touch and the touch position by receiving from the plurality of the receiving electrodes RX1 to RXm a sensing signal including information on a capacitance change amount changing according to the touch on a touch surface.

As shown in FIG. 1a, the touch sensor 10 may include the plurality of drive electrodes TX1 to TXn and the plurality of receiving electrodes RX1 to RXm. While FIG. 1a shows that the plurality of drive electrodes TX1 to TXn and the plurality of receiving electrodes RX1 to RXm of the touch sensor 10 form an orthogonal array, the present invention is not limited to this. The plurality of drive electrodes TX1 to TXn and the plurality of receiving electrodes RX1 to RXm has an array of arbitrary dimension, for example, a diagonal array, a concentric array, a 3-dimensional random array, etc., and an array obtained by the application of them. Here, “n” and “m” are positive integers and may be the same as each other or may have different values. The magnitude of the value may be changed depending on the embodiment.

The plurality of drive electrodes TX1 to TXn and the plurality of receiving electrodes RX1 to RXm may be arranged to cross each other. The drive electrode TX may include the plurality of drive electrodes TX1 to TXn extending in a first axial direction. The receiving electrode RX may include the plurality of receiving electrodes RX1 to RXm extending in a second axial direction crossing the first axial direction.

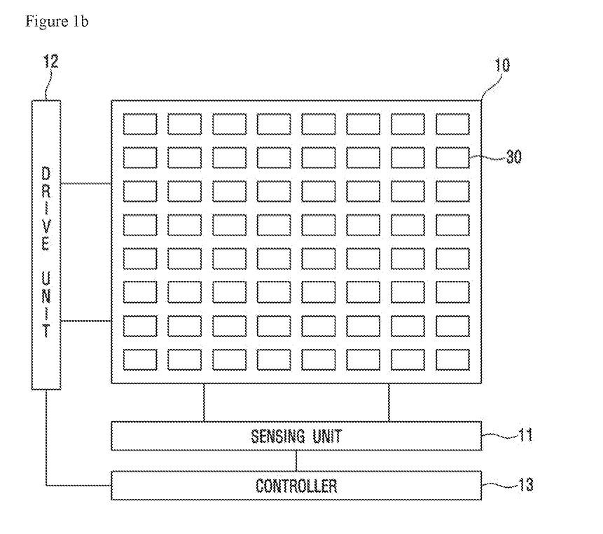

As shown in FIGS. 2a and 2b, in the touch sensor 10 according to the embodiment of the present invention, the plurality of drive electrodes TX1 to TXn and the plurality of receiving electrodes RX1 to RXm may be formed in the same layer. For example, the plurality of drive electrodes TX1 to TXn and the plurality of receiving electrodes RX1 to RXm may be formed on a top surface of a display module 200 to be described later.

Also, as shown in FIG. 2c, the plurality of drive electrodes TX1 to TXn and the plurality of receiving electrodes RX1 to RXm may be formed in different layers. For example, any one of the plurality of drive electrodes TX1 to TXn and the plurality of receiving electrodes RX1 to RXm may be formed on the top surface of the display module 200, and the other may be formed on a bottom surface of a cover 100 to be described later or may be formed within the display module 200.

The plurality of drive electrodes TX1 to TXn and the plurality of receiving electrodes RX1 to RXm may be made of a transparent conductive material (for example, indium tin oxide (ITO) or antimony tin oxide (ATO) which is made of tin oxide (SnO₂), and indium oxide (In₂O₃), etc.), or the like. However, this is only an example. The drive electrode TX and the receiving electrode RX may be also made of another transparent conductive material or an opaque conductive material. For instance, the drive electrode TX and the receiving electrode RX may include at least any one of silver ink, copper, and carbon nanotube (CNT). Also, the drive electrode TX and the receiving electrode RX may be made of metal mesh.

The drive unit 12 shown in FIG. 1a may apply a drive signal to the drive electrodes TX1 to TXn. In the embodiment of the present invention, one drive signal may be sequentially applied at a time to the first drive electrode TX1 to the n-th drive electrode TXn. The drive signal may be applied again repeatedly. This is only an example. The drive signal may be applied to the plurality of drive electrodes at the same time in accordance with the embodiment.

Through the receiving electrodes RX1 to RXm, the sensing unit 11 receives the sensing signal including information on a capacitance (Cm) 14 generated between the receiving electrodes RX1 to RXm and the drive electrodes TX1 to TXn to which the driving signal has been applied, thereby detecting whether or not the touch has occurred and where the touch has occurred. For example, the sensing signal may be a signal coupled by the capacitance (Cm) 14 generated between the receiving electrode RX and the drive electrode TX to which the driving signal has been applied. As such, the process of sensing the driving signal applied from the first drive electrode TX1 to the n-th drive electrode TXn through the receiving electrodes RX1 to RXm can be referred to as a process of scanning the touch sensor 10.

For example, the sensing unit 11 may include a receiver (not shown) which is connected to each of the receiving electrodes RX1 to RXm through a switch. The switch becomes the on-state in a time interval during which the signal of the corresponding receiving electrode RX is sensed, thereby allowing the receiver to sense the sensing signal from the receiving electrode RX. The receiver may include an amplifier (not shown) and a feedback capacitor coupled between the negative (−) input terminal of the amplifier and the output terminal of the amplifier, i.e., coupled to a feedback path. Here, the positive (+) input terminal of the amplifier may be connected to the ground. Also, the receiver may further include a reset switch which is connected in parallel with the feedback capacitor. The reset switch may reset the conversion from current to voltage that is performed by the receiver. The negative input terminal of the amplifier is connected to the corresponding receiving electrode RX and receives and integrates a current signal including information on the capacitance (Cm) 14, and then converts the integrated current signal into voltage. The sensing unit 11 may further include an analog to digital converter (ADC) (not shown) which converts the integrated data by the receiver into digital data. Later, the digital data may be input to a processor (not shown)and processed to obtain information on the touch on the touch sensor 10. The sensing unit 11 may include the ADC and processor as well as the receiver.

A controller 13 may perform a function of controlling the operations of the drive unit 12 and the sensing unit 11. For example, the controller 13 generates and transmits a drive control signal to the drive unit 12, so that the driving signal can be applied to a predetermined drive electrode TX1 at a predetermined time. Also, the controller 13 generates and transmits the drive control signal to the sensing unit 11, so that the sensing unit 11 may receive the sensing signal from the predetermined receiving electrode RX at a predetermined time and perform a predetermined function.

In FIG. 1a, the drive unit 12 and the sensing unit 11 may constitute a touch detection device (not shown) capable of detecting whether the touch has occurred on the touch sensor 10 or not and where the touch has occurred. The touch detection device may further include the controller 13. In the touch input device including the touch sensor 10, the touch detection device may be integrated and implemented on a touch sensing integrated circuit (IC). The drive electrode TX and the receiving electrode RX included in the touch sensor 10 may be connected to the drive unit 12 and the sensing unit 11 included in the touch sensing IC through, for example, a conductive trace and/or a conductive pattern printed on a circuit board, or the like. The touch sensing IC may be placed on a circuit board on which the conductive pattern has been printed, for example, a first printed circuit board (hereafter, referred to as a first PCB). According to the embodiment, the touch sensing IC may be mounted on a main board for operation of the touch input device.

As described above, a capacitance (Cm) with a predetermined value is generated at each crossing of the drive electrode TX and the receiving electrode RX. When an object like a finger approaches close to the touch sensor 10, the value of the capacitance may be changed. In FIG. 1a, the capacitance may represent a mutual capacitance (Cm). The sensing unit 11 senses such electrical characteristics, thereby being able to sense whether the touch has occurred on the touch sensor 10 or not and where the touch has occurred. For example, the sensing unit 11 is able to sense whether the touch has occurred on the surface of the touch sensor 10 comprised of a two-dimensional plane consisting of a first axis and a second axis.

More specifically, when the touch occurs on the touch sensor 10, the drive electrode TX to which the driving signal has been applied is detected, so that the position of the second axial direction of the touch can be detected. Likewise, when the touch occurs on the touch sensor 10, the capacitance change is detected from the reception signal received through the receiving electrode RX, so that the position of the first axial direction of the touch can be detected.

Up to now, although the operation mode of the touch sensor 10 sensing the touch position has been described on the basis of the mutual capacitance change amount between the drive electrode TX and the receiving electrode RX, the embodiment of the present invention is not limited to this. That is, as shown in FIG. 1b, it is also possible to detect the touch position on the basis of the change amount of a self-capacitance.

FIG. 1b is schematic views of a configuration of another capacitance type ouch sensor 10 included in the touch input device according to another embodiment of the present invention and the operation of the capacitance type touch sensor.

A plurality of touch electrodes 30 are provided on the touch sensor 10 shown in FIG. 1b. Although the plurality of touch electrodes 30 may be, as shown in FIG. 2d, disposed at a regular interval in the form of a grid, the present invention is not limited to this.

The drive control signal generated by the controller 13 is transmitted to the drive unit 12. On the basis of the drive control signal, the drive unit 12 applies the drive signal to the predetermined touch electrode 30 during a predetermined time period. Also, the drive control signal generated by the controller 13 is transmitted to the sensing unit 11. On the basis of the drive control signal, the sensing unit 11 receives the sensing signal from the predetermined touch electrode 30 during a predetermined time period. Here, the sensing signal may be a signal for the change amount of the self-capacitance formed on the touch electrode 30.

Here, whether the touch has occurred on the touch sensor panel 10 or not and/or the touch position are detected by the sensing signal detected by the sensing unit 11. For example, since the coordinate of the touch electrode 30 has been known in advance, whether the touch of the object on the surface of the touch sensor 10 has occurred or not and/or the touch position can be detected.

In the foregoing, for convenience of description, it has been described that the drive unit 2 and the sensing unit 11 operate individually as a separate block. However, the operation to apply the drive signal to the touch electrode 30 and to receive the sensing signal from the touch electrode 30 can be also performed by one drive and sensing unit.

The foregoing has described the touch input device including the touch sensor 10 capable of detecting whether or not the touch occurs and/or the touch position. The above-described touch sensor 10 is applied to the touch input device according to the embodiment of the present invention, so that it is possible to easily detect whether or not the touch occurs and/or the touch position. Besides, the touch input device according to the embodiment of the present invention can easily detect the magnitude of touch pressure to be described below. Hereinafter, the following detailed description will be provided by taking an example of a case where the touch pressure is detected in the touch input device according to the embodiment of the present invention.

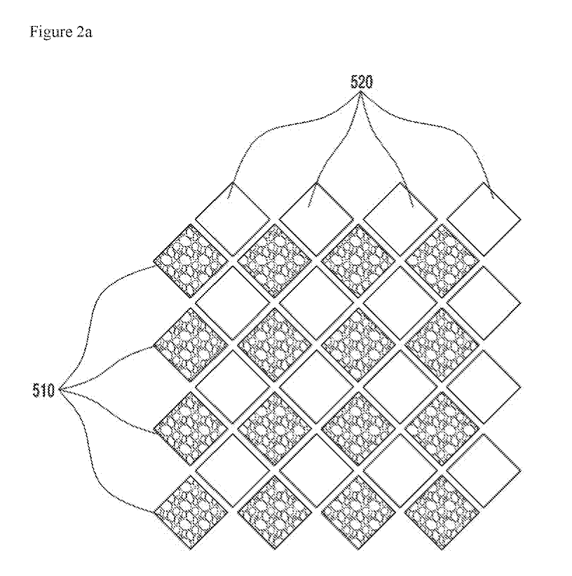

FIG. 3a is a schematic cross sectional view of the touch input device according to the embodiment of the present invention and is a cross sectional view briefly showing only some components necessary for detecting the touch pressure in the touch input device.

Referring to FIG. 3a, the touch input device according to the embodiment of the present invention includes the cover 100, the display module 200, a reference electrode 250, pressure electrodes 400a and 400b, and a substrate 500.

The cover 100 is a member to which touch by a predetermined object such as a user's finger and predetermined pressure are directly input. The cover 100 may be located at the top of the touch input device.

The cover 100 serves to protect the touch sensor 10 shown in FIG. 1a or 1b and the display module 200, etc.

The cover 100 may be made of transparent material-made glass or plastic in order that an image output from the display module 200 disposed under the cover 100 is visible from the outside. The cover 100 may be made of a flexible material which can be bent at a position thereof where the pressure is applied.

The display module 200 is disposed under the cover 100. Specifically, the display module 200 may be disposed on the bottom surface of the cover 100.

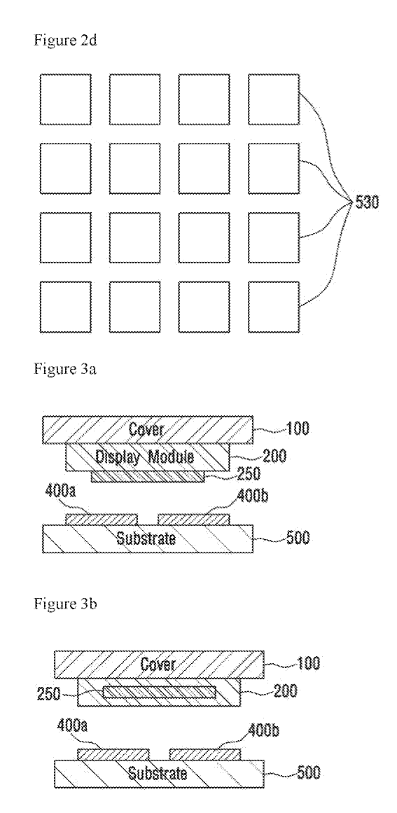

The display module 200 includes a liquid crystal display (LCD) panel and an organic light emitting diode (OLED) panel. This will be described with reference to FIGS. 5a and 5b.

FIG. 5a shows a display module 200A including the LCD panel, and FIG. 5b shows a display module 200B including the OLED panel.

As shown in FIG. 5a, the display panel 200A may include a liquid crystal layer 250 including a liquid crystal cell, a first substrate layer 251 and a second substrate a 252 which are disposed respectively on both sides of the liquid crystal layer 250 and include electrodes, a first polarization layer 253 formed on a side of the first substrate layer 251 in a direction facing the liquid crystal layer 250, and a second polarization layer 254 formed on a side of the second substrate layer 252 in the direction facing the liquid crystal layer 250. It is clear to those skilled in the art that the LCD panel may further include other structures for the purpose of performing the displaying function and may be modified. Here, the first substrate layer 251 may be made of color filter glass, and the second substrate layer 252 may be made of TFT glass. Also, according to the embodiment, at least one of the first substrate layer 251 and the second substrate layer 252 may be made of a bendable material such as plastic.

Though not shown the figures, the display module 200A may further include a backlight unit (not shown) disposed under the display panel 200A.

As shown in FIG. 5b, the display panel 200A may include an organic material layer 260, and a first substrate layer 261 and a second substrate layer 262 which are disposed respectively on both sides of the organic material layer 260. It is clear to those skilled in the art that the OLED panel may further include other structures for the purpose of performing the displaying function and may be modified. Here, the first substrate layer 261 may be made of encapsulation glass, and the second substrate layer 262 may be made of TFT glass. Also, according to the embodiment, at least one of the first substrate layer 261 and the second substrate layer 262 may be made of a bendable material such as plastic.

Referring back to FIG. 3a, the display module 200 may include a control circuit which receives a predetermined signal from an application processor (AP) or a central processing unit (CPU) on a main board for the operation of the touch input device and displays the contents that the user wants on the display panel. The control circuit for the operation of the display panel 200 may include a display panel control IC, a graphic controller IC, and a circuit required to operate other display panel.

The reference electrode 250 is additionally provided separately from the display module 200. The reference electrode 250 serves as a reference potential layer for detecting the touch pressure by using the pressure electrodes 400a and 400b. The reference electrode 250 is disposed on the bottom surface of the display module 200.

The pressure electrodes 400a and 400b may be disposed under the display module 200 and may be disposed apart from the display module 200 and the reference electrode 250 by a predetermined distance. A predetermined space may be formed between the pressure electrodes 400a and 400b and the display module 200 and the reference electrode 250. The predetermined space may be provided with a predetermined member (not shown), for example, a cushion, which can be compressed by an external force and can be restored to its original shape when the external force is removed.

The pressure electrodes 400a and 400b are firmed on the substrate 500. Here, the pressure electrodes 400a and 400b may be formed on the top surface of the substrate 500. Though not shown in the figures, the pressure electrodes 400a and 400b may be formed on the bottom surface of the substrate 500. Here, the pressure electrodes 400a and 400b may include a first pressure electrode 400a and a second pressure electrode 400b. Here, the first pressure electrode 400a and the second pressure electrode 400b may be electrically insulated from each other to perform different functions. For example, a touch pressure drive signal may be input to the first pressure electrode 400a and a touch pressure sensing signal may be output from the second pressure electrode 400b. Also, the first pressure electrode 400a and the second pressure electrode 400b may be electrically connected to each other to perform the same function. For example, both the first pressure electrode 400a and the second pressure electrode 400b may receive the touch pressure drive signal and may output the touch pressure sensing signal. This will be described with reference to FIGS. 2a to 2d.

The first pressure electrode 400a and the second pressure electrode 400b may be, as shown in FIG. 2a, composed of a plurality of lozenge-shaped electrodes. Here, the first pressure electrodes 400a may be composed of a plurality of first axial electrodes 510 connected to each other in the first axial direction, and the second pressure electrode 400b may be composed of plurality of second axial electrodes 520 connected to each other in the second axial direction orthogonal to the first axial direction. The lozenge-shaped electrodes of at least one of the first pressure electrode 400a and the second pressure electrode 400b are connected to each other through a bridge, so that the first pressure electrode 400a and the second pressure electrode 400b may be insulated from each other.

Further, the first pressure electrode 400a and the second pressure electrode 400b may be, as shown in FIG. 2b, composed of the plurality of first axial electrodes 510 and the plurality of second axial electrodes 520. The first pressure electrode 400a and the second pressure electrode 400b do not cross each other, and the first pressure electrode 400a and the second pressure electrode 400b may be arranged such that the second pressure electrodes 400b are connected to each other in a direction crossing the extension direction of the first pressure electrodes 400a.

Also, the first pressure electrode 400a and the second pressure electrode 400b may be, as shown in FIG. 2c, composed of the plurality of first axial electrodes 510 and the plurality of second axial electrodes 520 respectively. The first pressure electrode 400a and the second pressure electrode 400b may be arranged to cross each other.

Also, the first pressure electrode 400a and the second pressure electrode 400b may be, as shown in FIG. 2d, disposed at a regular interval in the form of a grid and may be electrically connected to each other. Through the example shown in FIG. 2d, the first pressure electrode 400a and the second pressure electrode 400b are electrically connected to each other to perform the same function.

Referring back to FIG. 3a, the touch pressure which is input to the cover 100 can be detected by using the first pressure electrode 400a and the second pressure electrode 400b. Hereinafter, various touch pressure detection methods will be described.

One method for detecting the touch pressure may be a method for detecting the touch pressure by using the touch pressure sensing signal output from any one of the first pressure electrode 400a and the second pressure electrode 400b. The touch pressure sensing signal includes information on the mutual capacitance change amount between the first pressure electrode 400a and the second pressure electrode 400b according to the distance change between the reference electrode 250 and the first and second pressure electrodes 400a and 400b due to the touch pressure which is input to the cover 100. Here, one of the first pressure electrode 400a and the second pressure electrode 400b is a drive electrode to which the touch pressure drive signal is applied, and the other is a receiving electrode to which the touch pressure sensing signal is output.

Another method for detecting the touch pressure may be a method for detecting the touch pressure by using the sensing signal output from the first pressure electrode 400a and the second pressure electrode 400b. The sensing signal includes information on the self-capacitance change amount of each of the first pressure electrode 400a and the second pressure electrode 400h according to the distance change between the reference electrode 250 and the first and second pressure electrodes 400a and 400b due to the touch pressure which is input to the cover 100. Here, the first pressure electrode 400a and the second pressure electrode 400b are respectively a drive electrode to which the touch pressure drive signal is applied and a receiving electrode to which the touch pressure sensing signal is output. The touch pressure drive signal and the touch pressure sensing signal may be separated by time and may be applied to the first pressure electrode 400a and the second pressure electrode 400b respectively.

Referring back to FIG. 3a, the substrate 500 may be nonconductive or may include an electrically floating conductive material. The meaning of what the substrate 500 is nonconductive or includes an electrically floating conductive material is that the substrate 500 on which the pressure electrodes 400a and 400b are formed is electrically insulated. When the substrate 500 is nonconductive, the substrate 500 may be, for example, made of a resin material such as plastic.

When the substrate 500 is electrically insulated, the first pressure electrode 400a and the second pressure electrode 400b can be directly formed on the substrate 500.

If the substrate 500 is composed of one metal which is entirely conductive, a conductive pressure electrode cannot be disposed directly on a conductive metal-made substrate. However, in the embodiment of the present invention, the pressure electrodes 400a and 400b can be formed directly on the top surface of the substrate 500 because the substrate 500 is electrically insulated. Therefore, no separate member is disposed between the pressure electrodes 400a and 400b and the substrate 500, so that there is an advantage that the total thickness of the touch input device can be reduced.

In addition, when the substrate 500 is composed of one metal which is entirely conductive, an insulation member, for example, a cushion, for insulating the pressure electrode from the metal-made substrate s be disposed between the conductive metal-made substrate and the pressure electrode. However, a parasitic capacitance may be formed between the metal-made substrate and the pressure electrode even if the insulation member such as a cushion is disposed between the metal-made substrate and the pressure electrode. The formed parasitic capacitance is very large because a distance between the metal-made substrate and the pressure electrode is quite small. Since the very large parasitic capacitance is reflected in the sensing signal from the pressure electrode and is outputted, the sensitivity of the touch pressure sensing may be reduced. However, in the embodiment of the present invention, the parasitic capacitance is not formed between the pressure electrodes 400a and 400b and the substrate 500 because the substrate 500 is electrically insulated. Accordingly, the parasitic capacitance between the pressure electrodes 400a and 400b and the substrate 500 is not reflected in the sensing signal output from the pressure electrodes 400a and 400b, so that the sensitivity of the touch pressure sensing is improved.

FIG. 3b is a schematic cross sectional view of the touch input device according to another embodiment of the present invention and is a cross sectional view briefly showing only some components necessary for detecting the touch pressure in the touch input device.

Referring to FIG. 3b, the touch input device according to the embodiment of the present invention includes the cover 100, the display module 200, the reference electrode 250, the pressure electrodes 400a and 400b, and the substrate 500.

The touch input device shown in FIG. 3b is different from the touch input device shown in FIG. 3a in the position of the reference electrode 250. Specifically, the reference electrode 250 is disposed within the display module 200.

The reference electrode 250 serves as a reference potential layer for detecting the touch pressure by using the pressure electrodes 400a and 400b.

The reference electrode 250 is disposed within the display module 200. Specifically, referring to FIG. 5a, the reference electrode 250 may be disposed at least one of between the first polarization layer 253 and the first substrate layer 251, between the first substrate layer 251 and the liquid crystal layer 250, between the liquid crystal layer 250 and the second substrate layer 252, and between the second substrate layer 252 and the second polarization layer 254. Also, referring to FIG. 5b, the reference electrode 250 may be disposed at least one of between the first substrate layer 261 and the organic material layer 260 and between the organic material layer 260 and the second substrate layer 262.

The touch pressure detection method using the pressure electrodes 400a and 400b is the same as the method described above with reference to FIG. 3a, with the difference being that the reference electrode 250 is located within the display module 200. Therefore, a detailed description thereof will be omitted.

FIG. 3c is a schematic cross sectional view of the touch input device according to further another embodiment of the present invention and is a cross sectional view briefly showing only some components necessary for detecting the touch pressure in the touch input device.

Referring to FIG. 3c, the touch input device according to the embodiment of the present invention includes the cover 100, the display module 200, the pressure electrodes 400a and 400b, and the substrate 500.

The touch input device shown in FIG. 3c is different from the touch input devices shown in FIGS. 3a and 3b in that the reference electrode 250 is not separately provided. The reference potential layer which plays the same role as that of the reference electrode 250 shown in FIGS. 3a and 3b may be at least one component of various components which constitute the display module 200 or the touch sensor. Here, the reference potential layer may have a ground potential (GND).

One method for detecting the touch pressure by using the pressure electrodes 400a and 400b may be a method for detecting the touch pressure by using the touch pressure sensing signal output from any one of the first pressure electrode 400a and the second pressure electrode 400b. The touch pressure sensing signal includes information on the mutual capacitance change amount between the first pressure electrode 400a and the second pressure electrode 400b according to the distance change between the reference potential layer and the first and second pressure electrodes 400a and 400b due to the touch pressure which is input to the cover 100. Here, one of the first pressure electrode 400a and the second pressure electrode 400b is a drive electrode to which the touch pressure drive signal is applied, and the other is a receiving electrode to which the touch pressure sensing signal is output.

Another method for detecting the touch pressure may be a method for detecting the touch pressure by using the sensing signal output from the first pressure electrode 400a and the second pressure electrode 400b. The sensing signal includes information on the self-capacitance change amount of each of the first pressure electrode 400a and the second pressure electrode 400b according to the distance change between the reference potential layer and the first and second pressure electrodes 400a and 400b due to the touch pressure which is input to the cover 100. Here, the first pressure electrode 400a and the second pressure electrode 400b are respectively a drive electrode to which the touch pressure drive signal is applied and a receiving electrode to which the touch pressure sensing signal is output. The touch pressure drive signal and the touch pressure sensing signal may be separated by time and may be applied to the first pressure electrode 400a and the second pressure electrode 400b respectively.

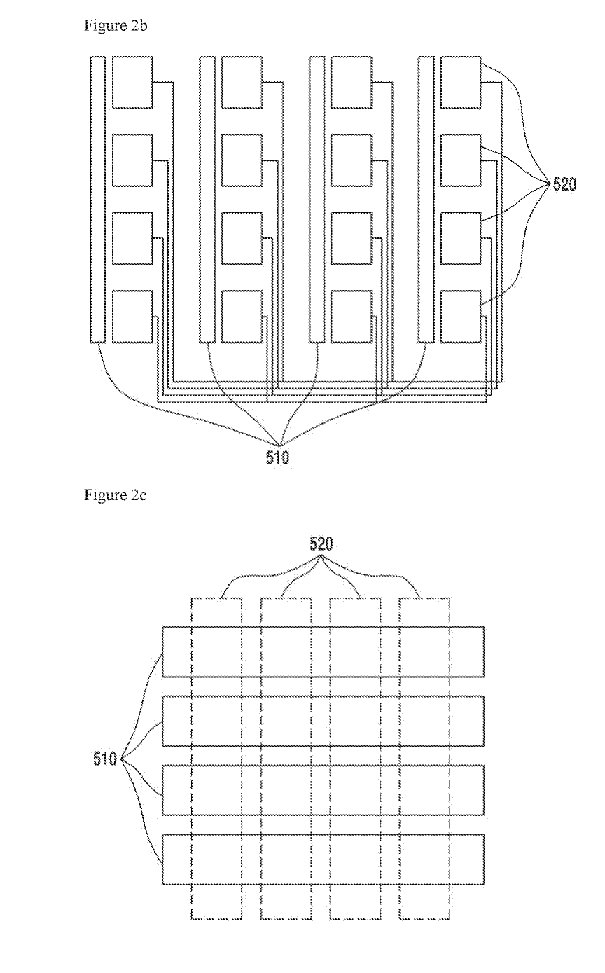

FIG. 4a is a schematic cross sectional view of the touch input device according to yet another embodiment of the present invention and is a cross sectional view briefly showing only some components necessary for detecting the touch pressure in the touch input device.

Referring to FIG. 4a, the touch input device according to yet another embodiment of the present invention includes the cover 100, the display module 200, the first pressure electrode 400a, the second pressure electrode 400b, and the substrate 500.

The touch input device shown in FIG. 4a is different from the touch input device shown in FIG. 3a in the positions of the first and second pressure electrodes 400a and 400b. Specifically, the first pressure electrode 400a and the second pressure electrode 400b are not disposed together substrate 500, and one of the first pressure electrode 400a and the second pressure electrode 400b is disposed on the bottom surface of the display module 200. In the figure, the first pressure electrode 400a is disposed on the bottom surface of the display module 200.

By this positional relationship, the second pressure electrode 400b is disposed at a predetermined distance below the first pressure electrode 400a. Here, although not shown in the figure, the second pressure electrode 400b may be disposed on the bottom surface of the substrate 500.

Since the first pressure electrode 400a and the second pressure electrode 400b are located in different layers, they may be overlapped with each other. For example, the first pressure electrode 400a and the second pressure electrode 400b may be composed of the plurality of first axial electrodes 510 and the plurality of second axial electrodes 520 respectively. The first pressure electrode 400a and the second pressure electrode 400b may be arranged to cross each other. Alternatively, as shown in FIG. 2a, the first lozenge-shaped axial electrode 510 and the second lozenge-shaped axial electrode 520 may be located in different layers, respectively.

The method for detecting the touch pressure by using the pressure electrodes 400a and 400b may be a method for detecting the touch pressure by using the sensing signal output from any one of the first pressure electrode 400a and the second pressure electrode 400b. The sensing signal includes information on the mutual capacitance change amount between the first pressure electrode 400a and the second pressure electrode 400b according to the distance change between the first pressure electrode 400a and the second pressure electrode 400b due to the touch pressure which is input to the cover 100. Here, one of the first pressure electrode 400a and the second pressure electrode 400b is a drive electrode to which the touch pressure drive signal is applied, and the other is a receiving electrode to which the touch pressure sensing signal is output.

Another method for detecting the touch pressure by using the pressure electrodes 400a and 400b may be a method for forming a reference potential in the display module 200 as shown in FIGS. 3a to 3c, and for detecting the touch pressure by using the sensing signal output from any one of the first pressure electrode 400a and the second pressure electrode 400b. The sensing signal includes information on the mutual capacitance change amount between the first pressure electrode 400a and the second pressure electrode 400b according to the distance change between the reference potential of the display module 200 and at least one of the first pressure electrode 400a and the second pressure electrode 400b due to the touch pressure which is input to the cover 100. Here, one of the first pressure electrode 400a and the second pressure electrode 400b is a drive electrode to which the touch pressure drive signal is applied, and the other is a receiving electrode to which the touch pressure sensing signal is output.

FIG. 4b is a schematic cross sectional view of the touch input device according to still another embodiment of the present invention and is a cross sectional view schematically showing only some components necessary for detecting the touch pressure in the touch input device.

Referring to FIG. 4b, the touch input device according to still embodiment of me present invention includes the cover 100, the display module 200, the first pressure electrode 400a, the second pressure electrode 400b, and the substrate 500.

The touch input device shown in 4b is different from the touch input device shown in FIG. 4a in the position of the first pressure electrode 400a. Specifically, the first pressure electrode 400a is disposed within the display module 200.

Specifically, referring to FIG. 5a, the first pressure electrode 400a may be disposed one of between the first polarization layer 253 and the first substrate layer 251, between the first substrate layer 251 and the liquid crystal layer 250, between the liquid crystal layer 250 and the second substrate layer 252, and between the second substrate layer 252 and the second polarization layer 254. Also, referring to FIG. 5b, the first pressure electrode 400a may be disposed one of between the first substrate layer 261 and the organic material layer 260 and between the organic material layer 260 and the second substrate layer 262.

FIG. 4c is a schematic cross sectional view of the touch input device according to still another embodiment of the present invention and is a cross sectional view schematically showing only some components necessary for detecting the touch pressure in the touch input device.

Referring to FIG. 4c, the touch input device according to the embodiment of the present invention includes the cover 100, the display module 200, the second pressure electrode 400b, and the substrate 500.

The touch input device shown in FIG. 4c does not show the first pressure electrode as compared with the touch input device shown in FIG. 4a because any of the components constituting the display module 200 serves as the first pressure electrode 400a shown in FIG. 4a. That is, it should be understood that, in FIGS. 4a and 4b, the first pressure electrode 400a is provided separately from the components constituting the display module 200, and in FIG. 4c, any one of the components constituting the display module 200 further performs a function of the first pressure electrode.

The above-described touch input devices according to various embodiments of the present invention shown in FIGS. 3a to 4c include in common the electrically floating substrate 500 and one or more pressure electrodes 400a or 400b disposed on the top surface of the substrate 500. Here, it should be noted that the electrically floating substrate 500 and the one or more pressure electrodes 400a or 400b are not applied to the touch input device shown in FIGS. 3a to 4c alone. Since the technical spirit of the present invention is to detect the touch pressure by using the electrically floating substrate 500 and the one or more pressure electrodes 400a or 400b, the substrate 500 and the one or more pressure electrodes 400a or 400b can be applied to the touch input device other than the touch input device shown in FIGS. 3a to 4c.

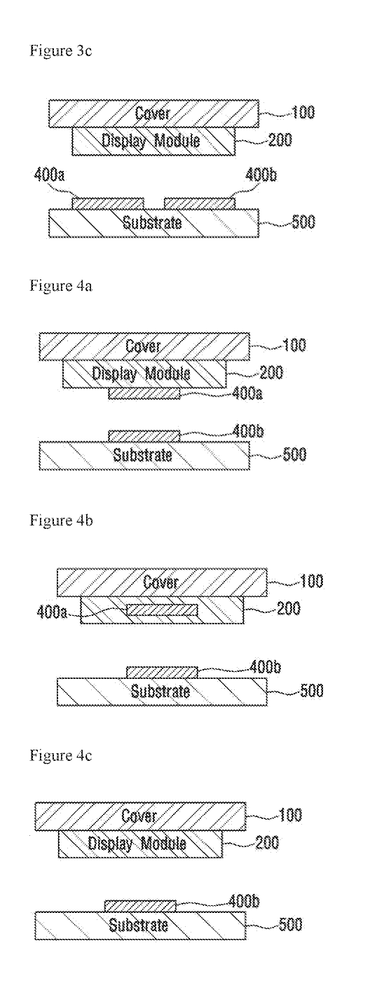

FIGS. 6a to 6b are views for describing the coupling relationship between the display module 200 and the substrate 500 which are shown in FIGS. 3a to 4b.

Referring to FIG. 6a, an edge portion of a substrate 500a is coupled to the bottom surface of the display module 200, and the remaining portion of the substrate 500a other than the edge portion is spaced apart from the display module 200 by a predetermined distance. The pressure electrode 400 is disposed on the top surface of the substrate 500a. Here, the pressure electrode 400 may be the first and second pressure electrodes 400a and 400b shown in FIGS. 3a to 3c, and may be the second pressure electrode 400b shown in FIGS. 4a to 4b.

In order for the substrate 500a to be electrically insulated, the substrate 500a may be nonconductive. For example, the substrate 500a may be made of a resin material such as plastic. Since the substrate 500a is nonconductive, the edge portion of the substrate 500a can be directly coupled to the bottom surface of the display module 200. Here, a double-sided adhesive tape (DAT) may be used to couple the edge portion of the substrate 500a to the bottom surface of the display module 200.

By using the nonconductive substrate 500a, the electrically isolated substrate 500 shown in FIGS. 3a to 4b can be implemented.

In FIG. 6a, the substrate 500a is nonconductive in order to electrically insulate the substrate 500a. However, the nonconductive substrate 500a, for example, the resin-made substrate 500a is several hundreds of micrometers thick, the strength of the substrate 500a is reduced and can be easily damaged by an external force. A method for solving such a problem will be described with reference to FIG. 6b.

Referring to FIG. 6b, a substrate 500b may be conductive. For example, the substrate 500b may be a metal such as steel, stainless steel, aluminum (Al), etc. In order to electrically float the conductive substrate 500b, an insulating member 550 is disposed between the display module 200 and an edge portion of the substrate 500b. Here, the insulating member 550 may be nonconductive and may be made of a resin material such as plastic.

The edge portion of the substrate 500b may be coupled to the insulating member 550 by using a double-sided adhesive tape (DAT), and the insulating member 550 may be also coupled to the bottom surface of the display module 200 by using the double-sided adhesive tape (DAT).

As shown in FIG. 6, while the substrate 500b is composed of a conductive material having electrical conductivity, the substrate 500b is electrically insulated from the display module 200 by the insulating member 500 and is not electrically connected to other components not shown in the drawings. Therefore, the conductive substrate 500b may be electrically floating. Accordingly, by using the conductive substrate 500b and the insulating member 550, the electrically floating substrate 500 in the touch input device shown in FIGS. 3a to 4b can be implemented.

As such, through the implementation of the electrically floating substrate 500 shown in FIGS. 3a to 4c by using the conductive substrate 500b and the insulating member 550 shown in FIG. 6b. there is an advantage in that the substrate 500b is not easily damaged by an external force even if the substrate 500b is formed to have a thickness of several hundreds of micrometers. There is also an advantage in that the conductive material-made substrate 500b can be electrically floating by using the insulating member 550.

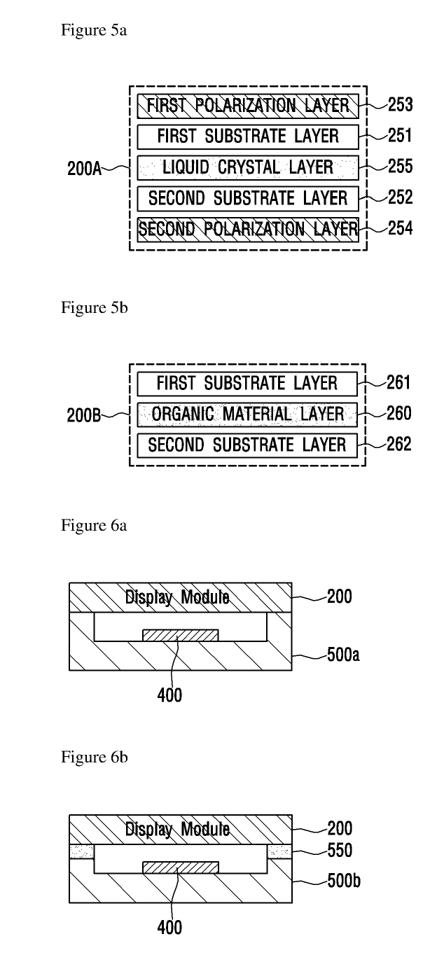

FIG. 7 is an entire cross sectional view of the touch input device including the display module 200 and the substrate 500a which are shown in FIG. 6a.

Referring to FIG. 7, the display module 200 is disposed below the cover 100, and the substrate 500 is coupled to the bottom of the display module 200. Since the substrate 500 is made of a resin material, the substrate 500 is electrically floating. The substrate 500 may have a thickness of about 200 μm or more. Though not shown in a separate drawing, a space in which air exists may be filled with a cushion made of an elastic material.

The pressure electrode 400 is disposed on the op surface of the substrate 500. In order to fix the pressure electrode 400 to the substrate 500, a double-sided adhesive tape (DAT) 450 may be used. Here, the pressure electrode 400 may have a thickness of about 75 μm and the double-sided adhesive tape 450 may have a thickness of about 30 μm.

The pressure electrode 400 and the display module 200 are spaced apart from each other, and air may exist between the pressure electrode 400 and the display module 200.

A mid-frame 600 may be coupled to the cover 100 through glue 650 and graphite 670 may be disposed on the top surface of the mid-frame 600. The graphite 670 serves to radiate heat.

A back cover 700 is disposed below the mid-frame 600 and the back cover 700 receives the cover 100, the display module 200, the pressure electrode 400, the substrate 500, the mid-frame 600, and a battery/main board 800. The back cover 700 is coupled with the cover 100 to form the appearance of the touch input device.

As described with reference to FIGS. 3a to 4c, a reference potential may be formed in the display module 200.

For reference, it is needless to say that the touch input device shown in FIG. 7 can be also composed of the display module 200, the insulating member 550, and the substrate 500b shown in FIG. 6b.

The touch input device shown in FIG. 7 is shown as including the graphite 670 without being limited thereto. The graphite 670 may not be included. In this case, the substrate 500 may come into direct contact with the mid-frame 600.

The touch input apparatus shown in FIG. 7 is shown as including the double-sided adhesive tape 450 without being limited thereto. The double-sided adhesive tape 450 may not be included.

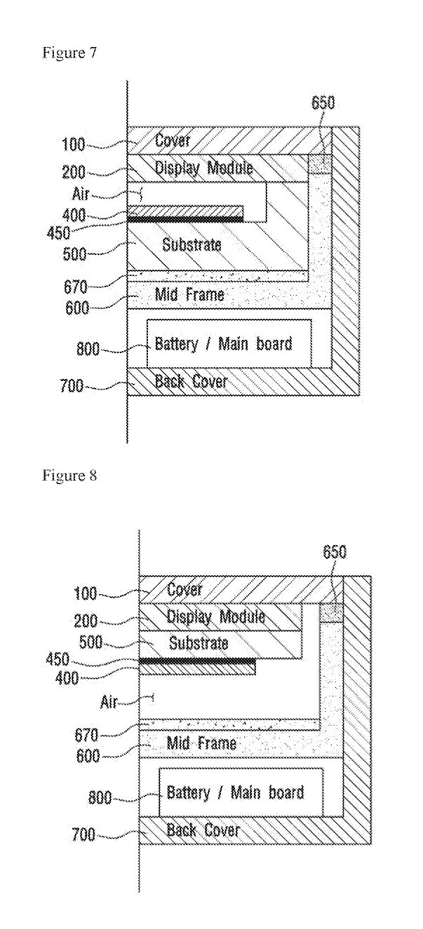

FIG. 8 is a cross sectional view of a modified example of the touch input device shown in FIG. 7.

Compared with the touch input device shown in FIG. 7, in the touch input device shown in FIG. 8, the pressure electrode 400 is disposed below the substrate 500, not on the substrate 500. There exists no air between the display module 200 and the substrate 500.

In the embodiment shown in FIG. 8, the display module 200 does not have a reference potential for the pressure electrode 400, and the mid-frame 600 may have a reference potential for the pressure electrode 400.

When the mid-frame 600 has a reference potential for the pressure electrode 400, the touch pressure can be detected by using the touch pressure sensing signal output from the pressure electrode 400. The touch pressure sensing signal includes information on the mutual capacitance change amount or the self-capacitance change amount according to the distance change between the pressure electrode 400 and the mid-frame 600 due to the touch pressure which is input to the cover 100. This pressure detection method is possible because the substrate 500 is nonconductive or includes an electrically floating conductor. That is, the substrate 500 physically exists between the pressure electrode 400 and the display module 200. However, when the mutual capacitance change amount or the self-capacitance change amount according to the distance change between the pressure electrode 400 and the mid-frame 600 is detected, the substrate 500 looks as if it does not electrically exist.

The touch input device shown in FIG. 8 is shown as including the graphite 670 without being limited thereto. The graphite 670 may not be included.

The touch input device shown in FIG. 8 is shown as including the double-sided. adhesive tape 450 without being limited thereto. The double-sided adhesive tape 450 may not be included.

Although the embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

1. A touch input device comprising:
a cover;
a display module disposed below the cover;
a substrate which is disposed below the display module and is nonconductive or comprises an electrically floating conductor; and
a pressure electrode formed on the substrate.

2. The touch input device of claim 1, wherein one or more of components constituting the display module have a reference potential for the pressure electrode.

3. The touch input device of claim 1, further comprising a reference electrode formed directly on a bottom surface of the display module, wherein the reference electrode has a reference potential for the pressure electrode.

4. The touch input device of claim 1, further comprising a reference electrode disposed within the display module, wherein the reference electrode has a reference potential for the pressure electrode.

5. The touch input device of claim 1, further comprising a mid-frame disposed below the substrate, wherein the mid-frame has a reference potential for the pressure electrode.

6. The touch input device of claim 1, wherein the pressure electrode is directly formed on the substrate.

7. A touch input device comprising:
a cover;
a display module disposed below the cover;
a substrate which is disposed below the display module and is nonconductive or comprises an electrically floating conductive material;
a first pressure electrode which is formed on the display module; and
a second pressure electrode which is formed on the substrate and is disposed below and spaced apart from the first pressure electrode at a predetermined distance.

8. The touch input device of claim 7, wherein the first pressure electrode is at least any one, of components constituting the display module.

9. The touch input device of claim 7, wherein the first pressure electrode is directly formed on a bottom surface of the display module.

10. The touch input device of claim 7, wherein the first pressure electrode is disposed within the display module.

11. The touch input device of claim 7, further comprising a mid-frame disposed below the substrate, wherein the mid-frame has a reference potential for at least any one of the first pressure electrode and the second pressure electrode.

12. The touch input device of claim 7, wherein the second pressure electrode is directly formed on the substrate.

13. The touch input device of claim 1, wherein, when the substrate is nonconductive, an edge portion of the substrate is connected to the bottom surface of the display module.

14. The touch input device of claim 1, wherein, when the substrate is an electrically floating conductor, the substrate comprises a conductive portion on which the pressure electrode is formed and an insulating member which connects an edge portion of the conductive portion with the bottom surface of the display module, and the insulating member is nonconductive.

15. The touch input device of claim 7, wherein, when the substrate is nonconductive, an edge portion of the substrate is connected to the bottom surface of the display module.

16. The touch input device of claim 7, wherein, when the substrate is an electrically floating conductor, the substrate comprises a conductive portion on which the pressure electrode is formed and an insulating member which connects an edge portion of the conductive portion with the bottom surface of the display module, and the insulating member is nonconductive.
